(19) United States
(12) Patent Application Publication
(10) Pub. No.: US 2007/0084113 A1
(43) Pub. Date: Apr. 19, 2007

(54) Flexible Container

(75) Inventors: Siegfried Hartmann, Ibbenburen (DE); Stefan Abelmann, Emsdetten (DE)

Correspondence Address: GUDRUN E. HUCKETT DRAUDT, LONSSTR. 59, WUPPERTAL, 42289, DE

(73) Assignee: NORDENIA DEUTSCHLAND EMSDETTEN GMBH, Emsdetten (DE)

(21) Appl. No.: 11/308,877

(22) Filed: May 19, 2006

(30) Foreign Application Priority Data
May 20, 2005 (DE) 10 2005 023 253.1

(51) Int. Cl. A01G 23/02

(52) U.S. Cl. 47/73

(57) ABSTRACT

A flexible container has a container body having a bottom and sidewalls. Stabilization elements connect the sidewalls in corner areas where the sidewalls adjoin one another. The stabilization elements have passages for bulk material to be filled into the flexible container. The stabilization elements are a grid structure web of extruded plastic material.

### BACKGROUND OF THE INVENTION

The invention relates to a flexible container, for example, a flexible bulk material container, comprising a container body comprised of a bottom as well as sidewalls and made from, for example, monofilaments and/or multi-filaments. The adjoining sidewalls are connected to one another in their corner areas by means of stabilization elements. The stabilization elements have passages for the bulk material.

Such a flexible container is disclosed, for example, in European patent application 1 300 345 A1. In this flexible container, the stabilization elements are comprised of transverse strips that are themselves made of filaments. It is disadvantageous in this connection that filament fibers can cause contamination. Between the individual transverse strips, empty spaces are provided as passages. The corresponding transverse strips are sewn to the neighboring sidewalls of the container body by means of a vertical strip. Filled-in bulk material can pass through the passages into the corner areas of the container which corner areas are delimited by the transverse strips; in this way, the fill volume of the corner areas can be utilized also. The stabilization elements serve in particular for keeping the bulging of the sidewalls to a minimum or for preventing the bulging of the sidewalls entirely.

A disadvantage of stabilization elements comprised of such transverse fabric strips is that they must be loadable to a relatively high degree; however, they are not abrasion-resistant (wear-resistant) even though they come into direct contact with the bulk material.

Therefore, such fabric strips are not really suitable for use, for example, in flexible containers in which paints, varnish, or e.g. food stuff are to be stored and transported.

### SUMMARY OF THE INVENTION

It is an object of the present invention to provide a flexible container of the aforementioned kind that can be equipped with stabilization elements, on the one hand, and that is able to receive sensitive bulk materials such as food stuff, paints, varnish and the like, on the other hand.

In accordance with the present invention, this is achieved in that the stabilization elements are provided as a grid structure web of extruded plastic material.

In this way, a flexible container is made available in which the stabilization elements that come into direct contact with the bulk material are highly abrasion resistant and absolutely clean. In this way, it is ensured that in the area of the stabilization element particles of the grid structure cannot become detached and cannot contaminate the bulk material. The grid structure is thus produced already during extrusion so that a subsequent weaving process is not needed.

The material made from extruded plastic material can be processed with minimal manufacturing expenditure to the grid structure web and can be sewn or fused to the sidewalls of the container. The passages within the grid structure web allow bulk material to penetrate into the corner areas of the container body so that the fill volume of the flexible container can be utilized almost completely. Bulging of the container body does not occur because the grid structure web completely stabilizes the sidewalls, respectively.

Preferably, the grid structure web is designed such that stays that extend in the longitudinal direction, i.e., the longitudinal stays, are thicker than the transversely oriented transverse stays. It is, of course, also possible to provide the stays in a diagonal orientation, respectively. The grid structure web has preferably such a structure or such a configuration that at the crossing points or intersections of transverse, longitudinal, or diagonal stays an increased material accumulation of the extruded plastic material is present. This material accumulation can be the result of stays resting on top one another so that approximately twice the material thickness is provided and the material accumulation is caused in this way in this area. Moreover, it is also possible that the crossing points or intersections are connected such with one another that no exact angular transitions are present but instead, for example, rounded areas are provided with which the filled-in corner areas provided in this crossing area are provided with increased loadability. The grid structure web can be comprised of polypropylene or, for example, of polyethylene. The grid structure web can be comprised of plastic film material.

### BRIEF DESCRIPTION OF THE DRAWING

FIG. 1 is a perspective illustration of an embodiment of a flexible container in accordance with the present invention.

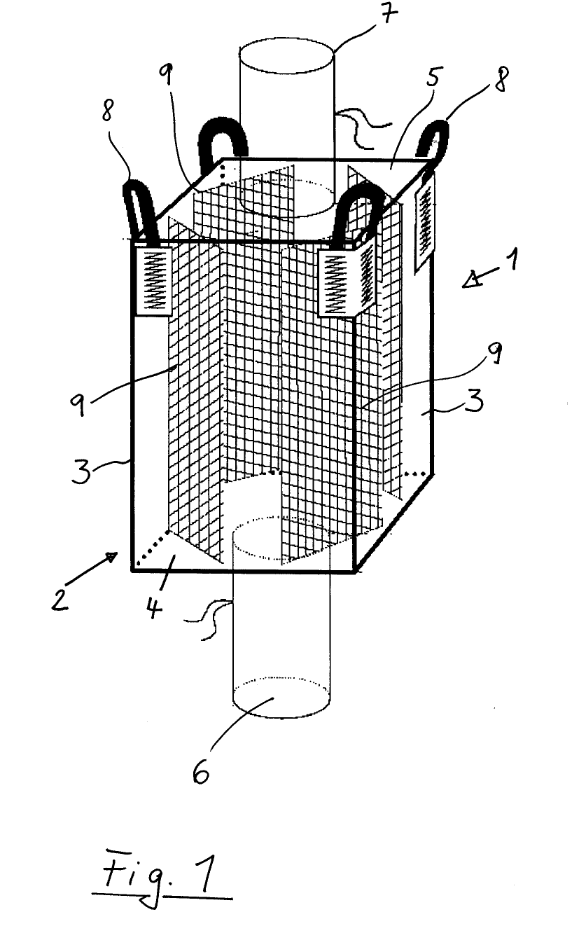

FIG. 2 shows a portion of an embodiment of a grid structure web.

### DESCRIPTION OF THE PREFERRED EMBODIMENTS

The drawing shows only the parts of the embodiment of the flexible container that are required for a proper understanding of the invention. The container, referenced as a whole at 1, has a container body 2 with sidewalls 3, a bottom 4, and a top 5. An outlet socket 6 is provided at the bottom 4; a fill socket 7 is provided at the top 5. By means of carrying handles 8 sewn to the sidewalls 3 the container 1 can be lifted. In the corner areas of the sidewalls, stabilization elements referenced at 9 are provided. They extend from the bottom 4 of the container 1 longitudinally upwardly to the top 5 of the container 1 and end below the top 5 at a spacing relative to the top 5. The stabilization elements 9 are configured as a grid structure web that is sewn to the sidewalls 3 of the container 1. In the area of the respective needle holes, a sealing strip made of hose material can be provided.

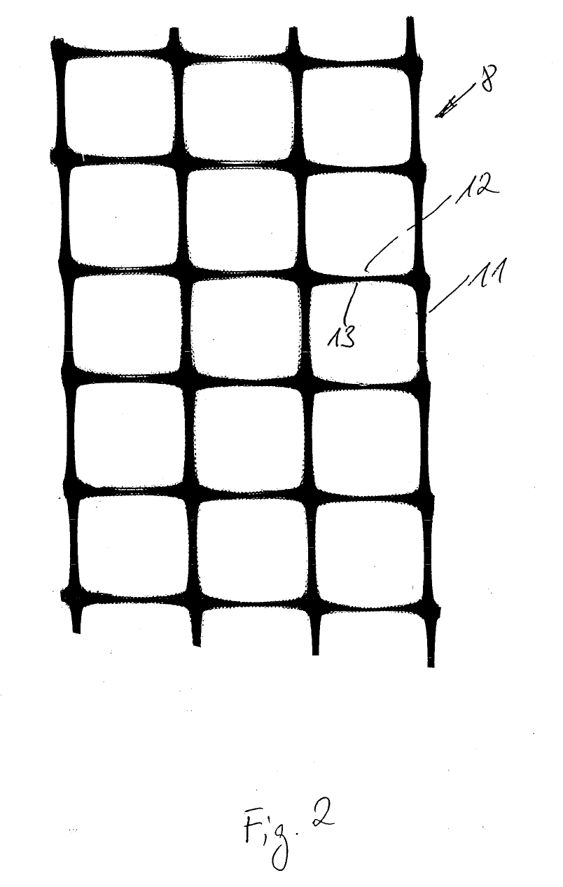

The grid structure web provided as a stabilizing element 9 is comprised of extruded plastic material wherein the grid structure web is produced such that at the respective crossing or intersection area of longitudinal stays 11 and transverse stays 12 a material accumulation is provided in such a way that no exact angular corner areas result; instead, the crossing point areas are provided with a greater portion of plastic material while in the central area, for example, indicated at 13 in FIG. 2, a relatively narrow stay area is provided. As a whole, the longitudinal stays 11 are made thicker than the transverse stays 12 so that an optimal stabilization behavior with optimized material distribution is provided. By employing the extruded plastic material, the stabilization elements are particle-free and, therefore, can be considered to be highly abrasion-resistant (wear-resistant); when used in a container utilized as a storage means or transport means for food stuff, paints, varnish, and the like, the stabilization elements do not present a risk with regard to contamination of the bulk material caused by abrasion.

In other respects, the flexible container can be configured so as to be capable of electrostatic discharge and/or can be coated and/or can be provided with a liner, wherein the corresponding stabilization elements can also be provided on the liner.

The specification incorporates by reference the entire disclosure of German priority document 10 2005 023 253.1 having a filing date of May 20, 2005.

While specific embodiments of the invention have been shown and described in detail to illustrate the inventive principles, it will be understood that the invention may be embodied otherwise without departing from such principles.

What is claimed is:

1. A flexible container comprising:
a container body having a bottom and sidewalls;
stabilization elements connecting the sidewalls in corner areas where the sidewalls adjoin one another;
wherein the stabilization elements comprise passages for bulk material to be filled into the flexible container;
wherein the stabilization elements are a grid structure web of extruded plastic material.

2. The flexible container according to claim 1, wherein longitudinal stays aligned in a longitudinal direction of the grid structure web are thicker than transverse stays of the grid structure web that extend transversely to the longitudinal stays.

3. The flexible container according to claim 2, wherein crossing areas are formed where the longitudinal stays and the transverse stays cross one another, wherein at the crossing areas more of the extruded plastic material is present than in areas of the grid structure web outside of the crossing areas so that material accumulations are formed at the crossing points.

4. The flexible container according to claim 3, wherein the material accumulations are formed by the extruded plastic material being adjacently positioned; stacked; or adjacently positioned and stacked.

5. The flexible container according to claim 1, wherein areas of the grid structure web to be sewn to the container body are thicker than areas of the grid structure web positioned between edge areas of the grid structure web.

6. The flexible container according to claim 1, wherein the grid structure web is sewn to the sidewalls of the container body.

7. The flexible container according to claim 1, wherein the grid structure web is fused to the sidewalls of the container body.

8. The container according to claim 1, wherein the grid structure web is comprised of plastic film material.

9. The flexible container according to claim 1, wherein the grid structure web is comprised of polypropylene.

10. The flexible container according to claim 1, wherein the grid structure web is comprised of polyethylene.

11. The flexible container according to claim 1, wherein the container body is comprised of monofilaments; multi-filaments; or monofilaments and multi-filaments.
